(19) United States
(12) Patent Application Publication
(10) Pub. No.: US 2023/0195187 A1
(43) Pub. Date: Jun. 22, 2023

(54) PCI-E MODULE CAPABLE OF BEING DISASSEMBLED AND ASSEMBLED WITHOUT TOOL

(71) Applicant: INSPUR SUZHOU INTELLIGENT TECHNOLOGY CO., LTD., Suzhou, Jiangsu (CN)

(72) Inventor: Tsung Ho CHEN, Suzhou, Jiangsu (CN)

(21) Appl. No.: 17/642,085

(22) PCT Filed: Jun. 28, 2020
(86) PCT No.: PCT/CN2020/098401

§ 371 Date: May 5, 2022

(30) Foreign Application Priority Data
Dec. 9, 2019 (CN) 201910863563.6

(51) Int. Cl. G06F 1/18

(52) U.S. Cl. CPC G06F 1/185; G06F 1/186

(57) ABSTRACT

A control system, a switch, and a method for controlling an execution device. The control system comprises a processor, a control module, and address resolution modules. The processor is connected to the control module by means of a peripheral component interconnection high-speed PCIe bus, the control module is connected to one or more address resolution modules by means of address buses, and each address resolution module is configured to be connected to one execution device, wherein address information of a port to be controlled on each execution device is preconfigured on the processor, and the address information is used for enabling the processor to address to a corresponding address resolution module by means of the control module.

### CROSS-REFERENCE TO RELATED APPLICATIONS

The present application claims priority to Chinese Patent Application No. 201910863563.6 entitled “PCI-E MODULE FOR TOOL-LESS ASSEMBLY/DISASSEMBLY” and filed to China National Intellectual Property Administration on Sep. 12, 2019, the entire content of which is incorporated herein by reference.

### FIELD

The present invention relates to the field of servers, and particularly to a PCI-e module for tool-less assembly/disassembly.

### BACKGROUND

PCI-Express (peripheral component interconnect express, abbreviated as “PCI-e”) is a standard of high-speed serial computer expansion bus, used for interconnecting peripheral components of computers or communication platforms, and is commonly applied to products such as servers. In order to increase the maintainability of the equipment and to meet the assembly requirements, the PCI-e card can support plugging and unplugging, a server or a storage server sometimes adopts a vertical PCI-e adapter card, and besides golden fingers of the adapter card needs to be fixed with a slot of the adapter card, an I/O iron sheet of the adapter card also needs to be fixed to avoid unstable signals when in vibration; the existing PCI-e card is fixed in a server mostly by screws, namely, the PCI-e card is directly inserted into a PCI-e interface, then a blocking sheet of the PCI-e card is mounted on a case by screws, and various tools such as screwdrivers and screws are needed for assembly or disassembly, so that there is a lot of inconvenience in operation.

### SUMMARY OF THE INVENTION

The present invention aims to overcome the defects in the prior art and provide a PCI-e module for tool-less assembly/disassembly, wherein a fixing steel sheet is provided on one side of a rear window, the lower end of a vertical portion of the fixing steel sheet is riveted on the rear window through a rivet, and when the fixing steel sheet is rotated to be positioned, an I/O iron sheet of an adapter card is pressed by a horizontal portion to be fixed, so that the vibration of the PCI-e adapter card is avoided, the signal stability of the PCI-e adapter card is ensured, the tool-less plugging and unplugging of the PCI-e adapter card are realized, and the disassembling and assembling efficiency of the PCI-e adapter card is improved.

In order to achieve the above-mentioned objective, the present invention adopts the following technical solutions:

Provided is a PCI-e module for tool-less assembly/disassembly, which comprises a case, a rear window, interface cards and a fixing steel sheet, wherein PCI-e connectors (not shown) are arranged at a bottom of the case, and a lower end of each interface card is inserted into each PCI-e connector through golden fingers; wherein an I/O iron sheet is arranged on one side of each interface card, a connecting plate is arranged on one side of each I/O iron sheet, the connecting plate is connected to the interface card, and a buckle plate is arranged on one side of an upper portion of each interface card; the rear window is arranged at one end of the case, a plurality of separation grooves are formed in the rear window, each interface card is mounted on one side of each separation groove, and the buckle plates of the interface cards are lapped on an upper portion of the rear window; the fixing steel sheet is arranged on one side of the rear window, the fixing steel sheet comprises vertical portions and a horizontal portion, a clamping groove is formed in the horizontal portion, the vertical portions are arranged at two ends of the horizontal portion, a through hole is formed in the lower end of each vertical portion, a rivet penetrates through each through hole to rivet each vertical portion on a side wall of the rear window, and when the fixing steel sheet is rotated to be positioned, an upper wall of the rear window and the buckle plates are mounted inside the clamping groove; the I/O iron sheet of an adapter card is pressed by the horizontal portion to be fixed, so that the vibration of the PCI-e adapter card is avoided, the signal stability of the PCI-e adapter card is ensured, the tool-free plugging and unplugging of the PCI-e adapter card are realized, and the disassembling and assembling efficiency of the PCI-e adapter card is improved; when the PCI-e adapter card is disassembled, the fixing steel sheet is rotated around the rivets to separate the fixing steel sheet from the buckle plates of the I/O iron sheets, and thus golden fingers of the PCI-e adapter card is pulled out from the PCI-e connector, thereby completing the disassembly of the PCI-e adapter card.

In a further preferred implementation of the present technical solution, a plurality of positioning posts are arranged on an upper portion of the upper wall of the rear window, and a positioning groove clamped with each positioning post is formed on one side of each buckle plate. The arrangement of the positioning posts and the positioning grooves not only ensures the mounting accuracy of the PCI-e adapter card, but also limits the movement of the PCI-e adapter card in the front-rear direction, and thus ensures the mounting stability of the PCI-e adapter card.

In a further preferred implementation of the present technical solution, a first surrounding plate is arranged on one side of a lower portion of each separation groove, two ends of the first surrounding plate are connected to the rear window, a slot is formed between the first surrounding plate and the rear window, a plug is arranged at a lower end of each I/O iron sheet, and the plug is inserted into the slot. The arrangement of the slot prevents the PCI-e adapter card from shaking, and thus ensures the mounting stability of the PCI-e adapter card.

In a further preferred implementation of the present technical solution, the horizontal portion is in interference fit with the buckle plates and the upper wall of the rear window, so that the clamping effect of the fixing steel sheet is ensured.

In a further preferred implementation of the present technical solution, a plurality of elastic lugs are arranged on one side of an upper portion of the horizontal portion, and the elastic lugs protrude towards one side of the buckle plates. The arrangement of the elastic lugs enhances the clamping force between the horizontal portion and the buckle plates, and ensures the mounting stability of the I/O iron sheets.

In a further preferred implementation of the present technical solution, an upper wall of the clamping groove is an arc-shaped plate structure, and a middle portion of the upper wall of the clamping groove protrudes toward one side of the buckle plates. In this way, the clamping effect of the horizontal portion on the buckle plates and the rear window is enhanced, and meanwhile, a front portion of the upper wall of the clamping groove is tilted, so that the buckle plates and the upper wall of the rear window can be quickly and accurately inserted into the horizontal portion.

In a further preferred implementation of the present technical solution, a stopper arm is arranged at one end of each vertical portion, a stopper post is arranged on one side of each stopper arm, and the stopper posts are fixedly mounted on side walls of the rear window. The arrangement of the stopper posts prevents the fixing steel sheet from over-rotating.

In a further preferred implementation of the present technical solution, a stopper sheet is arranged on one side of each vertical portion, the stopper sheets are riveted on the vertical portions through rivets, a front end of each stopper sheet extends out of each vertical portion, and a rear end of the stopper sheet is flush with a rear portion of the vertical portion. The arrangement of the stopper sheets ensures the rotation accuracy of the fixing steel sheet and ensures the fixing effect of the PCI-e adapter card. Clamping hooks are arranged on upper and lower sides of each stopper sheet, respectively, clamping slots matched with the clamping hooks are formed in the side walls of the rear window, respectively, and after the buckle plates are tightly pressed by the horizontal portion, the clamping hooks are inserted into the clamping slots, so that the fixing steel sheet is prevented from rotating; when the PCI-e adapter is disassembled, the stopper sheets are pulled off towards the middle by hand to separate the clamping hooks from the clamping slots, and then the fixing steel sheet is rotated to disassemble the PCI-e adapter card.

In a further preferred implementation of the present technical solution, a cross section of the clamping hook is a right triangle, wherein the legs of the clamping hook are close to a front end of the stopper sheet. The hypotenuse of the clamping hook reduces the resistance of the rear window to the clamping hook when the fixing steel sheet is rotated to be positioned, so that the fixing steel sheet is conveniently positioned; the legs prevent the clamping hooks from being separated from the clamping slots after the fixing steel sheet is positioned, and the positioning stability of the fixing steel sheet is ensured.

In a further preferred implementation of the present technical solution, a second surrounding plate is integrally formed on one side of each vertical portion, and each stopper sheet is mounted inside a hollow groove formed between the second surrounding plate and the vertical portion. The arrangement of the second surrounding plates limits the moving range of the stopper sheets, and the stopper sheets are prevented from being deformed due to excessive force applied when the PCI-e adapter card is disassembled.

The Beneficial Effects of the Present Invention are as Follows:

1. A fixing steel sheet is arranged on one side of a rear window, the lower end of a vertical portion of the fixing steel sheet is riveted on the rear window through a rivet, and when the fixing steel sheet is rotated to be positioned, an I/O iron sheet of an adapter card is pressed by a horizontal portion to be fixed, so that the vibration of the PCI-e adapter card is avoided, the signal stability of the PCI-e adapter card is ensured, the tool-free plugging and unplugging of the PCI-e adapter card are realized, and the disassembling and assembling efficiency of the PCI-e adapter card is improved.

2. A plurality of positioning posts are arranged on an upper portion of the upper wall of the rear window, and a positioning groove clamped with each positioning post is formed on one side of each buckle plate. The arrangement of the positioning posts and the positioning grooves not only ensures the mounting accuracy of the PCI-e adapter card, but also limits the movement of the PCI-e adapter card in the front-rear direction, and thus ensures the mounting stability of the PCI-e adapter card.

3. A first surrounding plate is arranged on one side of a lower portion of each separation groove, two ends of the first surrounding plate are connected to the rear window, a slot is formed between the first surrounding plate and the rear window, a plug is arranged at a lower end of each I/O iron sheet, and the plug is inserted into the slot. The arrangement of the slot prevents the PCI-e adapter card from shaking, and thus ensures the mounting stability of the PCI-e adapter card.

4. The horizontal portion is in interference fit with the buckle plates and the upper wall of the rear window, so that the clamping effect of the fixing steel sheet is ensured.

5. A plurality of elastic lugs are arranged on one side of an upper portion of the horizontal portion, and the elastic lugs protrude towards one side of the buckle plates. The arrangement of the elastic lugs enhances the clamping force between the horizontal portion and the buckle plates, and ensures the mounting stability of the I/O iron sheets.

6. An upper wall of the clamping groove is an arc-shaped plate structure, and a middle portion of the upper wall of the clamping groove protrudes toward one side of the buckle plates. In this way, the clamping effect of the horizontal portion on the buckle plates and the rear window is enhanced, and meanwhile, a front portion of the upper wall of the clamping groove is tilted, so that the buckle plates and the upper wall of the rear window can be quickly and accurately inserted into the horizontal portion.

7. A stopper arm is arranged at one end of each vertical portion, a stopper post is arranged on one side of each stopper arm, and the stopper posts are fixedly mounted on side walls of the rear window. The arrangement of the stopper posts prevents the fixing steel sheet from over-rotating.

8. A stopper sheet is arranged on one side of each vertical portion, the stopper sheets are riveted on the vertical portions through rivets, a front end of each stopper sheet extends out of each vertical portion, and a rear end of the stopper sheet is flush with a rear portion of the vertical portion. The arrangement of the stopper sheets ensures the rotation accuracy of the fixing steel sheet and ensures the fixing effect of the PCI-e adapter card. Clamping hooks are arranged on upper and lower sides of each stopper sheet, respectively, clamping slots matched with the clamping hooks are formed in the side walls of the rear window, respectively, and after the buckle plates are tightly pressed by the horizontal portion, the clamping hooks are inserted into the clamping slots, so that the fixing steel sheet is prevented from rotating; when the PCI-e adapter is disassembled, the stopper sheets are pulled off towards the middle by hand to separate the clamping hooks from the clamping slots, and then the fixing steel sheet is rotated to disassemble the PCI-e adapter card.

9. A cross section of the clamping hook is a right triangle, wherein the legs of the clamping hook are close to a front end of the stopper sheet. The hypotenuse of the clamping hook reduces the resistance of the rear window to the clamping hook when the fixing steel sheet is rotated to be positioned, so that the fixing steel sheet is conveniently positioned; the legs prevent the clamping hooks from being separated from the clamping slots after the fixing steel sheet is positioned, and the positioning stability of the fixing steel sheet is ensured.

10. A second surrounding plate is integrally formed on one side of each vertical portion, and each stopper sheet is mounted inside a hollow groove formed between the second surrounding plate and the vertical portion. The arrangement of the second surrounding plates limits the moving range of the stopper sheets, and the stopper sheets are prevented from being deformed due to excessive force applied when the PCI-e adapter card is disassembled.

### BRIEF DESCRIPTION OF THE DRAWINGS

FIG. 1 is a schematic structural diagram of a PCI-e module for tool-less assembly/disassembly according to the present invention.

FIG. 2 is a partial schematic structural diagram of a rear window of the PCI-e module for tool-less assembly/disassembly according to the present invention.

FIG. 3 is a schematic structural diagram of an interface card of the PCI-e module for tool-less assembly/disassembly according to the present invention.

FIG. 4 is a partial schematic diagram of another side of the interface card of the PCI-e module for tool-less assembly/disassembly according to the present invention.

FIG. 5 is an assembly schematic diagram of a rear window and a fixing steel sheet of the PCI-e module for tool-less assembly/disassembly according to the present invention.

FIG. 6 is a partial exploded diagram of the fixing steel sheet of the PCI-e module for tool-less assembly/disassembly according to the present invention.

FIG. 7 is a partial enlarged schematic diagram of a portion A of the PCI-e module for tool-less assembly/disassembly according to the present invention.

FIG. 8 is a partial enlarged schematic diagram of a portion B of the PCI-e module for tool-less assembly/disassembly according to the present invention.

FIG. 9 is a schematic structural diagram of a stopper sheet of the PCI-e module for tool-less assembly/disassembly according to the present invention.

### DETAILED DESCRIPTION OF THE INVENTION

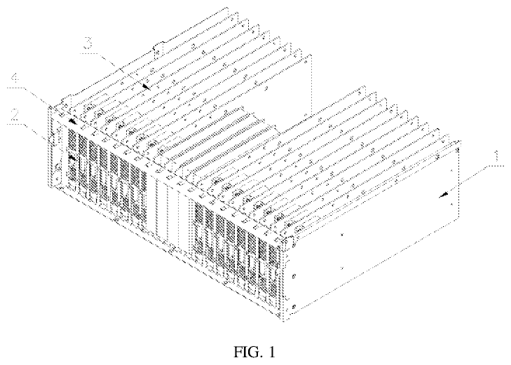

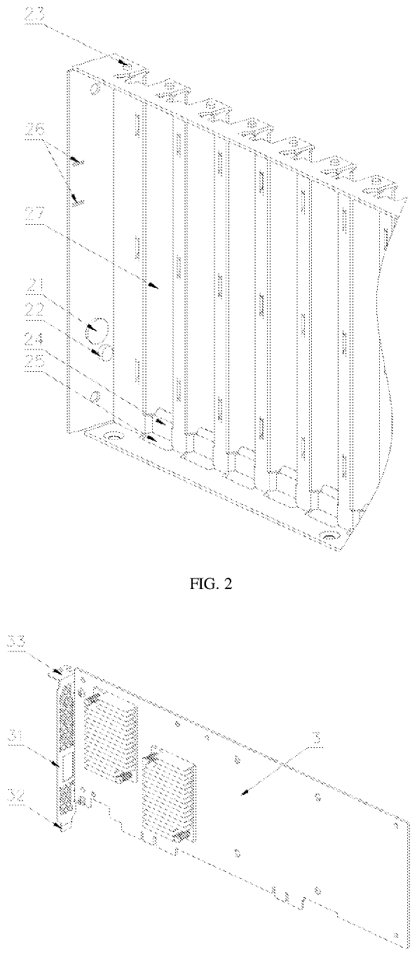

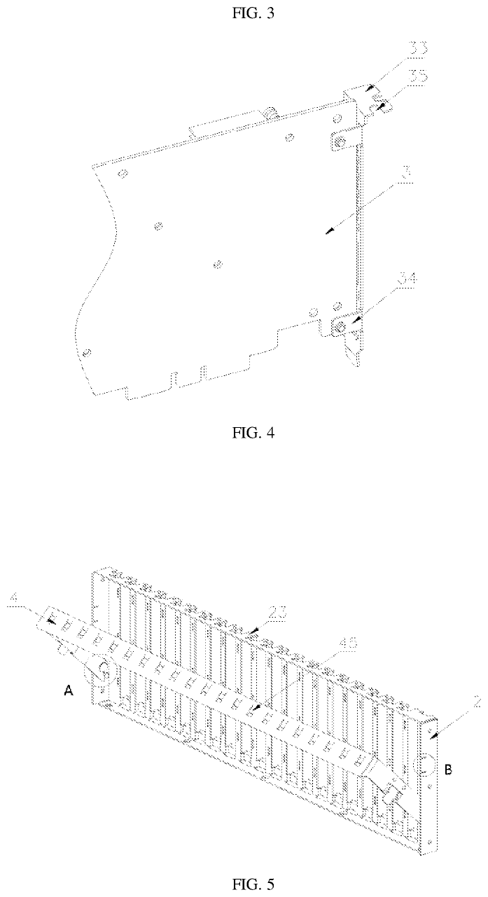

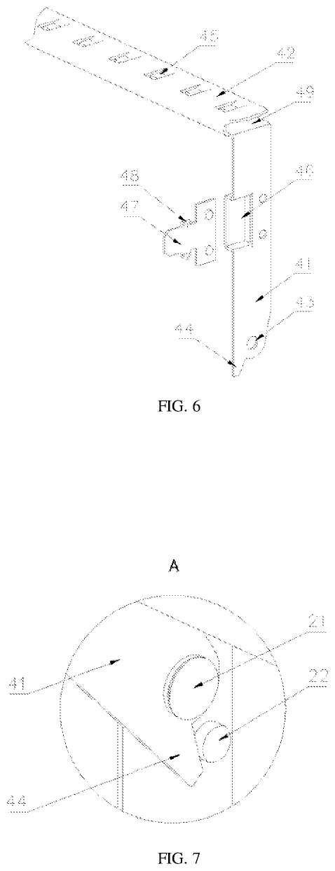

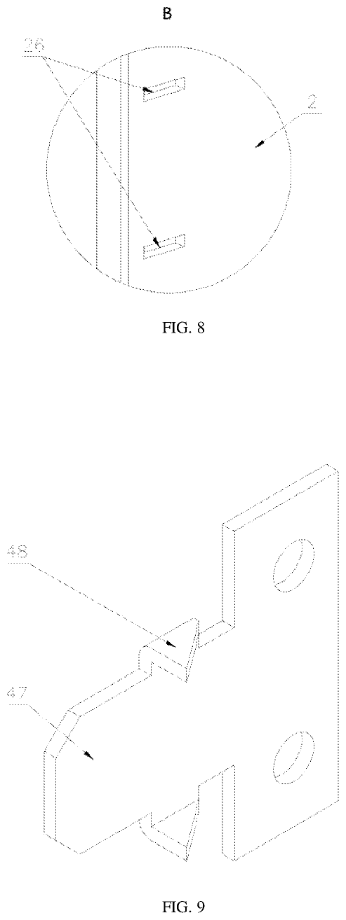

The technical solutions in the embodiments of the present invention are clearly and completely described below with reference to FIGS. 1 to 9, and it is obvious that the described embodiments are only a part of the embodiments of the present invention, and not all of the embodiments. Based on the embodiments of the present invention, all other embodiments obtained by those skilled in the art without creative work shall fall within the protection scope of the present invention.

In the description of the present invention, it is to be understood that directions or positional relationships indicated by terms “longitudinal”, “lateral”, “upper”, “lower”, “front”, “rear”, “left”, “right”, “vertical”, “horizontal”, “top”, “bottom”, “inside”, “outside” and the like are those shown based on the accompanying drawings, and are merely intended to facilitate the description rather than indicate or imply that the indicated device or element must have a specific direction and must be configured and operated according to the specific direction. Therefore, these directions or positional relationships should not be construed as limiting the present invention.

Provided is a PCI-e module for tool-less assembly/disassembly, which comprises a case 1, a rear window 2, interface cards 3 and a fixing steel sheet 4, wherein PCI-e connectors (not shown) are arranged at a bottom of the case 1, and a lower end of each interface card 3 is inserted into each PCI-e connector through golden fingers; wherein an I/O iron sheet 31 is arranged on one side of each interface card 3, a connecting plate 34 is arranged on one side of each I/O iron sheet 31, the connecting plate 34 is connected to the interface card 3, and a buckle plate 33 is arranged on one side of an upper portion of each interface card 3; the rear window 2 is arranged at one end of the case 1, a plurality of evenly distributed separation grooves 27 are formed in the rear window 2, each interface card 3 is mounted on one side of each separation groove 27, and the buckle plates 33 of the interface cards 3 are lapped on an upper portion of the rear window 2; the fixing steel sheet 4 is arranged on one side of the rear window 2, the fixing steel sheet 4 comprises vertical portions 41 and a horizontal portion 42, a clamping groove 49 is formed in the horizontal portion 42, the vertical portions 41 are arranged at two ends of the horizontal portion 42, a through hole 43 is formed in the lower end of each vertical portion 41, a rivet 21 penetrates through each through hole 43 to rivet each vertical portion 41 on a side wall of the rear window 2, and when the fixing steel sheet 4 is rotated to be positioned, an upper wall of the rear window 2 and the buckle plates 33 are mounted inside the clamping groove 49; the I/O iron sheet of an adapter card is pressed by the horizontal portion 42 to be fixed, so that the vibration of the PCI-e adapter card is avoided, the signal stability of the PCI-e adapter card is ensured, the tool-free plugging and unplugging of the PCI-e adapter card are realized, and the disassembling and assembling efficiency of the PCI-e adapter card is improved; when the PCI-e adapter card is disassembled, the fixing steel sheet 4 is rotated around the rivets 21 to separate the fixing steel sheet 4 from the buckle plates 33 of the I/O iron sheets 31, and thus golden fingers of the PCI-e adapter card is pulled out from the PCI-e connector, thereby completing the disassembly of the PCI-e adapter card.

In this embodiment, a plurality of positioning posts 23 are arranged on an upper portion of the upper wall of the rear window 2, and a positioning groove 35 clamped with each positioning post 23 is formed on one side of each buckle plate 33. The arrangement of the positioning posts 23 and the positioning grooves 35 not only ensures the mounting accuracy of the PCI-e adapter card, but also limits the movement of the PCI-e adapter card in the front-rear direction, and thus ensures the mounting stability of the PCI-e adapter card.

In this embodiment, a first surrounding plate 24 is arranged on one side of a lower portion of each separation groove 27, two ends of the first surrounding plate 24 are connected to the rear window 2, a slot 25 is formed between the first surrounding plate 24 and the rear window 2, a plug 32 is arranged at a lower end of each I/O iron sheet 31, and the plug 32 is inserted into the slot 25; the arrangement of the slot 25 prevents the PCI-e adapter card from shaking, and thus ensures the mounting stability of the PCI-e adapter card.

In this embodiment, the horizontal portion 42 is in interference fit with the buckle plates 33 and the upper wall of the rear window 2, so that the clamping effect of the fixing steel sheet 4 is ensured.

In this embodiment, a plurality of elastic lugs 45 are arranged on one side of an upper portion of the horizontal portion 42, and the elastic lugs 45 protrude towards one side of the buckle plates 33; the arrangement of the elastic lugs 45 enhances the clamping force between the horizontal portion 42 and the buckle plates 33, and ensures the mounting stability of the I/O iron sheets 31.

In this embodiment, an upper wall of the clamping groove 49 is an arc-shaped plate structure, and a middle portion of the upper wall of the clamping groove 49 protrudes toward one side of the buckle plates 33. In this way, the clamping effect of the horizontal portion 42 on the buckle plates 33 and the rear window 2 is enhanced, and meanwhile, a front portion of the upper wall of the clamping groove 49 is tilted, so that the buckle plates 33 and the upper wall of the rear window 2 can be quickly and accurately inserted into the horizontal portion 42.

In this embodiment, a stopper arm 44 is arranged at one end of each vertical portion 41, a stopper post 22 is arranged on one side of each stopper arm 44, and the stopper posts 22 are fixedly mounted on side walls of the rear window 2. The arrangement of the stopper posts 22 prevents the fixing steel sheet 4 from over-rotating.

In this embodiment, a stopper sheet 47 is arranged on one side of each vertical portion 41, the stopper sheets 47 are riveted on the vertical portions 41 through rivets 21, a front end of each stopper sheet 47 extends out of each vertical portion 41, and a rear end of the stopper sheet 47 is flush with a rear portion of the vertical portion 41. The arrangement of the stopper sheets 47 ensures the rotation accuracy of the fixing steel sheet 4 and ensures the fixing effect of the PCI-e adapter card. Clamping hooks 48 are arranged on upper and lower sides of each stopper sheet 47, respectively, clamping slots 26 matched with the clamping hooks 48 are formed in the side walls of the rear window 2, respectively, and after the buckle plates 33 are tightly pressed by the horizontal portion 42, the clamping hooks 48 are inserted into the clamping slots 26, so that the fixing steel sheet 4 is prevented from rotating; when the PCI-e adapter is disassembled, the stopper sheets 47 are pulled off towards the middle by hand to separate the clamping hooks 48 from the clamping slots 26, and then the fixing steel sheet 4 is rotated to disassemble the PCI-e adapter card.

In this embodiment, a cross section of the clamping hook 48 is a right triangle, wherein the legs of the clamping hook 48 are close to a front end of the stopper sheet 47. The hypotenuse of the clamping hook reduces the resistance of the rear window 2 to the clamping hook 48 when the fixing steel sheet 4 is rotated to be positioned, so that the fixing steel sheet 4 is conveniently positioned; the legs prevent the clamping hooks 48 from being separated from the clamping slots 26 after the fixing steel sheet 4 is positioned, and the positioning stability of the fixing steel sheet 4 is ensured.

In this embodiment, a second surrounding plate 46 is integrally formed on one side of each vertical portion 41, and each stopper sheet 47 is mounted inside a hollow groove formed between the second surrounding plate 46 and the vertical portion 41. The arrangement of the second surrounding plates 46 limits the moving range of the stopper sheets 47, and the stopper sheets 47 are prevented from being deformed due to excessive force applied when the PCI-e adapter card is disassembled.

The foregoing is merely illustrative and explanatory of the present invention, and various modifications and additions or substitutions with similar methods which are made to the specific embodiments described by those skilled in the art shall fall within the protection scope of the present invention without departing from the scope of the present invention as defined in the claims.

### LIST OF REFERENCE

1: case
2: rear window
21: rivet
22: stopper post
23: positioning post
24: first surrounding plate
25: slot
26: clamping slot
27: separation groove
3: interface card
31: I/O iron sheet
32: plug
33: buckle plate
34: connecting plate
35: positioning groove
4: fixing steel sheet
41: vertical portion
42: horizontal portion
43: through hole
44: stopper arm;
45: elastic lug;
46: second surrounding plate
47: stopper sheet
48: clamping hook
49: clamping groove

1. A PCI-e module for tool-less assembly/disassembly, comprising a case, a rear window, interface cards and a fixing steel sheet, wherein PCI-e connectors are arranged at a bottom of the case, and a lower end of each interface card is inserted into each PCI-e connector through golden fingers; wherein an I/O iron sheet is arranged on one side of each interface card, a connecting plate is arranged on one side of each I/O iron sheet, the connecting plate is connected to the interface card, characterized in that, a buckle plate is arranged on one side of an upper portion of each interface card; the rear window is arranged at one end of the case, a plurality of separation grooves are formed in the rear window, the interface card is mounted on one side of each separation groove, and the buckle plates of the interface cards are lapped on an upper portion of the rear window; the fixing steel sheet is arranged on one side of the rear window, the fixing steel sheet comprises vertical portions and a horizontal portion, a clamping groove is formed in the horizontal portion, the vertical portions are arranged at two ends of the horizontal portion, a through hole is formed in a lower end of each vertical portion, a rivet penetrates through each through hole to rivet each vertical portion on a side wall of the rear window, and when the fixing steel sheet is rotated to be positioned, an upper wall of the rear window and the buckle plates are mounted inside the clamping groove.

2. The PCI-e module for tool-less assembly/disassembly according to claim 1, wherein a plurality of positioning posts are arranged on the upper portion of the upper wall of the rear window, and a positioning groove clamped with each positioning post is formed on one side of each of the buckle plates.

3. The PCI-e module for tool-less assembly/disassembly according to claim 1, wherein a first surrounding plate is arranged on one side of a lower portion of each of the separation grooves, two ends of the first surrounding plate are connected to the rear window, a slot is defined between the first surrounding plate and the rear window, a plug is arranged at a lower end of each I/O iron sheet, and the plug is inserted into the slot.

4. The PCI-e module for tool-less assembly/disassembly according to claim 1, wherein the horizontal portion is in interference fit with the buckle plates and the upper wall of the rear window.

5. The PCI-e module for tool-less assembly/disassembly according to claim 1, wherein a plurality of elastic lugs are arranged on one side of an upper portion of the horizontal portion, and the elastic lugs protrude toward one side of the buckle plates.

6. The PCI-e module for tool-less assembly/disassembly according to claim 1, wherein an upper wall of the clamping groove is an arc-shaped plate structure, and a middle portion of the upper wall of the clamping groove protrudes toward one side of the buckle plates.

7. The PCI-e module for tool-less assembly/disassembly according to claim 1, wherein a stopper arm is arranged at one end of each of the vertical portions, a stopper post is arranged on one side of each stopper arm, and the stopper posts are fixedly mounted on the side walls of the rear window.

8. The PCI-e module for tool-less assembly/disassembly according to claim 7, wherein a stopper sheet is arranged on one side of each of the vertical portion the stopper sheets are riveted on the vertical portions through rivets, a front end of each stopper sheet extends out of each of the vertical portions, a rear end of the stopper sheet is flush with a rear portion of the vertical portion, clamping hooks are arranged on an upper side and a lower side of each stopper sheet, respectively, clamping slots matched with the clamping hooks are formed in the side walls of the rear window, respectively, and after the buckle plates are pressed by the horizontal portion, the clamping hooks are inserted into the clamping slots.

9. The PCI-e module for tool-less assembly/disassembly according to claim 8, wherein a cross section of the clamping hook is a right triangle, and legs of the clamping hook are close to the front end of the stopper sheet.

10. The PCI-e module for tool-less assembly/disassembly according to claim 8, wherein a second surrounding plate is integrally formed on one side of each of the vertical portions, and each stopper sheet is mounted inside a hollow groove formed between the second surrounding plate and the vertical portion.

11. The PCI-e module for tool-less assembly/disassembly according to claim 9, wherein a second surrounding plate is integrally formed on one side of each of the vertical portions, and each stopper sheet is mounted inside a hollow groove formed between the second surrounding plate and the vertical portion.
